(19) United States
(12) Patent Application Publication
(10) Pub. No.: US 2011/0109055 A1
(43) Pub. Date: May 12, 2011

(54) WHEELED CARRYING DEVICE

(75) Inventors: Jacob W. Tol, (US); Sharon L. Slabbekoorn, Grand Rapids, MI (US); Clinton J. Tol, Grand Rapids, MI (US)

(73) Assignee: GBJ Development Group, LLC, Grand Rapids, MI (US)

(21) Appl. No.: 12/717,577

(22) Filed: Mar. 4, 2010

Related U.S. Application Data
(60) Provisional application No. 61/260,120, filed on Nov. 11, 2009.

(51) Int. Cl. B62B 1/18

(52) U.S. Cl. 280/47.31

(57) ABSTRACT

A wheeled carrying device comprising a lightweight frame having a wheel mounted at one end of the frame and a handle at the other end of the frame. Removably suspended from the frame is a container in which objects to be carried can be placed. The frame includes a downwardly extending stop, such that, with the container removed, the frame can be inverted and objects can be carried on the inverted side of the frame, with the now upwardly projecting stop preventing the object from sliding into the wheel.

### RELATED APPLICATION

This application claims priority to U.S. provisional patent application Ser. No. 61/260,120 entitled PORTABLE LEVER TO AID IN THE TRANSPORT OF HEAVY OBJECTS, filed Nov. 11, 2009.

### FIELD OF THE INVENTION

The present invention relates to the field of wheeled carrying devices.

### SUMMARY OF THE INVENTION

The present invention is a wheeled carrying device comprising a lightweight frame having a wheel mounted at one end of the frame and a handle at the other end of the frame. Removably suspended from the frame is a container in which objects to be carried can be placed.

These and other aspects, objects and features of the invention will be more fully understood and appreciated by reference to the written specification and appended drawings.

### DESCRIPTION OF THE DRAWINGS

FIG. 1 is a perspective view of a device made in accordance with a preferred embodiment of the invention;

FIG. 2 is an enlargement of the circled area 2 from FIG. 1;

FIG. 3 is a side elevational view of the preferred embodiment device; and

FIG. 4 is a top plan view of the preferred embodiment device.

### DESCRIPTION OF THE PREFERRED EMBODIMENT

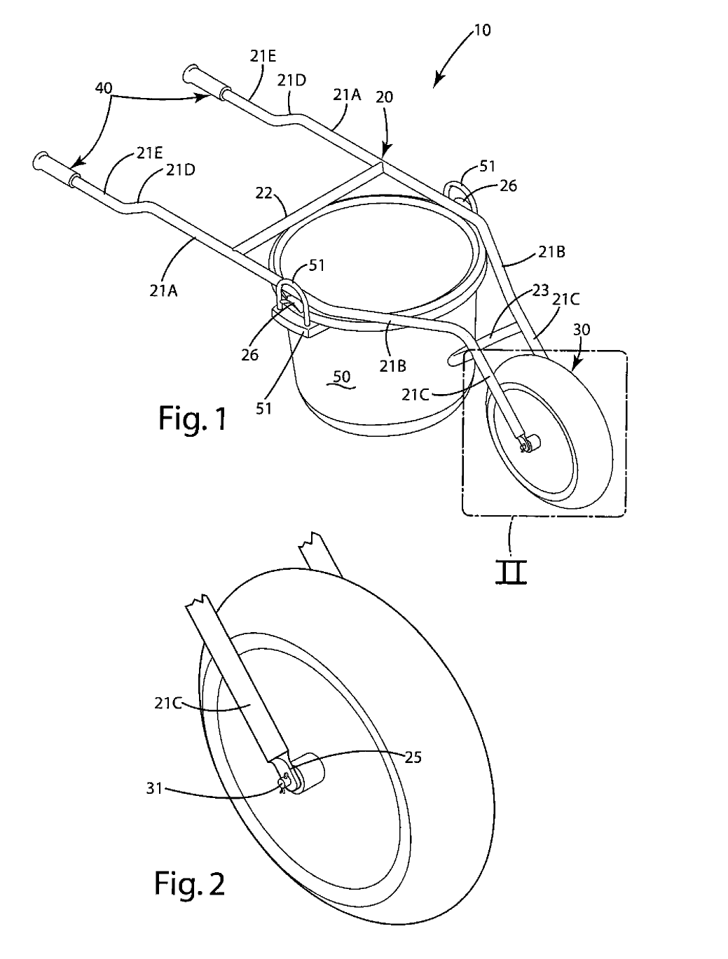

In the preferred embodiment device 10, a lightweight frame 20 includes a wheel 30 mounted at one end and a pair of handles 21e capped by hand grips 40 at the opposite end (FIG. 1). In between, a container 50 is releasably suspended from frame 20.

Frame 20 is lightweight, being made of two side members 21, a cross member 22, and a U-shaped cross member 23. The various frame members are preferably made of lightweight, but strong and sturdy metal tubing or the like. Frame side members 21 define spaced generally parallel and generally straight central portions 21 (FIGS. 1, 3 and 4), which terminate at their forward ends at inwardly turned forward portions 21b. Forward portions 21b extend inwardly towards one another. Potions 21b terminate at downwardly projecting wheel support tines 21e. Located in the end of each frame tine portion 21c is a flanged member 25 having an aperture therein for receiving the axle 31 of wheel 30 (FIG. 2). Suitable securing pins can be used to thereby secure wheel 30 to frame 20 at flanges 25.

At their rear ends, central portions 21a join downwardly and rearwardly angled short portions 21d, which terminate at rearwardly extending, generally parallel spaced handles 21e. Handles 21e are also generally parallel to the plane of central portions 21a. Handles 21e are capped with hand grips 40.

The various portions of frame side members 21 are preferably formed by bending the metal tubing into a shape defining the various portions. Alternatively, plural tubing members can be welded together at the different angles necessary to form frame side members as described above.

The angle A between members 21b and 21c is approximately 130°. The angle B between center portion 21a and the downwardly projecting portion 21d is approximately 150°. Similarly the inside angle C between members 21d and handles 21e is approximately 150°. While these angles can vary by plus or minus 10°, the approximate angles as indicated are preferred.

Frame cross member 22 joins central portions 21a together at a point spaced sufficiently rearwardly along the length of central portions 21a that it does not interfere with the opening in removably mounted container 50. U-shaped cross member 23, also referred to as a “stop member” for reasons which become apparent below, joins the downwardly extending tine portions 21c. U-shaped cross member 23 projects downwardly, as viewed in the figures, from tine portions 21c. However, removable container 50 can be removed from frame 20 and frame 20 can be inverted, such that U-shaped member 23 is projecting upwardly, and serves as a stop. In that position large bulky items can be placed on frame 20 and prevented from sliding down into wheel 30 by U-shaped stop member 23.

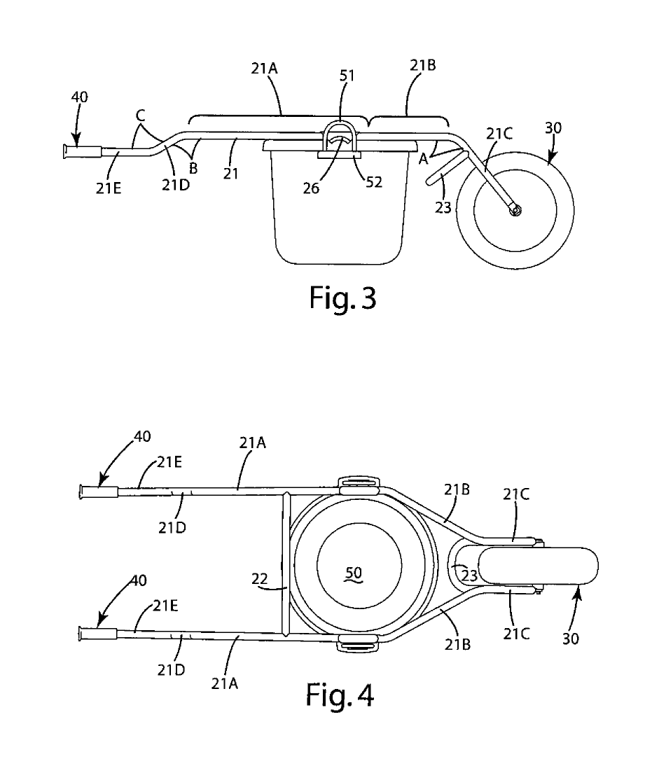

Attached to frame 20 towards the forward end of generally straight load carrying portions 21a of frame side members 21 are a pair of outwardly projecting support members 26. Support members 26 are preferably arcuately shaped, arching upwardly, for receiving arcuately shaped handles 51 on container 50. As shown in FIGS. 1 and 3, handles 51 are not yet seated on mating arcuate members 26, but rather are shown in the process of being seated for purposes of illustration. Handles 51 are attached to flanges 52 which project outwardly from opposite sides of container 50.

In use, container 50 can be attached to frame 20 by seating handles 51 on acutely shaped receiving supports 26. Container 50 can be loaded with objects to be transported, and then transported by a user grasping hand grips 40, raising the handle end of frame 20 slightly and pushing it forward so that it rolls on wheel 30. In use, one might have several different containers 50 so that several workers could be filling the containers with objects. Another person could be moving from worker to worker as a container is filled, bringing the worker an empty container 50 and attaching the filled container 50 to frame 20, and then transporting the filled container 50 to another location.

As noted above, large bulky objects can be conveyed from place to place by inverting frame 21 and loading them on that portion of support members 21a which in the figures shown appear to be the bottom surfaces of frame members 21a. U-shaped cross member 23 projects upwardly when frame 20 is inverted, and acts as a stop to prevent such bulky objects from sliding into wheel 30 as they are conveyed from place to place.

Of course, it is understood that the foregoing is merely a preferred embodiment of the invention, and that various changes and alterations can be made without departing from the spirit and broader aspects thereof.

1. A wheeled carrying device comprising:
a frame having a wheel at one end and a handle at the other end;
said frame including a pair of spaced side members, each with a support projecting generally laterally therefrom for receiving the spaced handles of a container, whereby a container can be conveyed from place to place by hanging its handles on said supports, and can be removed from said frame by removing said handles from said supports.

2. The device of claim 1 which includes a container with a pair of handles on opposite sides thereof, removeably hanging from said supports on said frame.

3. The device of claim 2 in which said supports are preferably arcuately shaped, arching upwardly, for receiving arcuately shaped handles on said container.

4. The device of claim 2 in which said frame side members include downwardly projecting forward wheel supporting tines joined by a stop member which projects downwardly from the downwardly projecting tines;
said device being invertible such that said downwardly projecting tines are oriented generally horizontally and said stop member is projecting upwardly from said tines instead of downwardly, whereby objects can be loaded onto said frame in abutting engagement with said stop member and conveyed.

5. The device of claim 4 in which said frame side members define spaced central portions which terminate at their forward ends at inwardly turned forward portions, which in turn terminate at said downwardly projecting wheel supporting tines; said central portions terminating at their rear portions at downwardly and rearwardly angled short portions, which in turn terminate at rearwardly extending, generally parallel spaced handles.

6. The device of claim 5 in which a frame cross member joins said side members together at a point spaced sufficiently rearwardly along the length of said side members from said laterally projecting supports that it does not interfere with the opening in a removeably mounted container.

7. The device of claim 5 in which said side members are formed into said handles, said short portions, said central portions, said forward portions and said tines by bending metal tubing into a shape defining said portions.

8. The device of claim 5 in which said side members are formed into said handles, said short portions, said central portions, said forward portions and said tines by welding said portions into a unit.

9. The device of claim 5 in which the angle between said forward members and said tines is about 130°; the angle between said center portion and said short portions is approximately 150°; and the angle between said short members and said handles is approximately 150°.

10. The device of claim 5 in which a frame cross member joins said side members together at a point spaced sufficiently rearwardly along the length of said side members from said laterally projecting supports that it does not interfere with the opening in a removeably mounted container.

11. The device of claim 1 in which said frame side members include downwardly projecting forward wheel supporting tines joined by a generally U-shaped cross member which projects downwardly from the downwardly projecting tines;
said device being invertible such that said downwardly projecting tines are oriented generally horizontally and said U-shaped cross member is projecting upwardly from said tines instead of downwardly, whereby objects can be loaded onto said frame in abutting engagement with said U-shaped cross member and conveyed.

12. The device of claim 11 in which said frame side members define spaced central portions which terminate at their forward ends at inwardly turned forward portions, which in turn terminate at said downwardly projecting wheel supporting tines; said central portions terminating at their rear portions at downwardly and rearwardly angled short portions, which in turn terminate at rearwardly extending, generally parallel spaced handles.

13. The device of claim 12 in which a frame cross member joins said side members together at a point spaced sufficiently rearwardly along the length of said side members from said laterally projecting supports that it does not interfere with the opening in a removeably mounted container.

14. The device of claim 13 wherein the angle between said forward members and said tines is about 130°; the angle between said center portion and said short portions is approximately 150°; and the angle between said short members and said handles is approximately 150°.

15. The device of claim 1 in which said frame side members define spaced central portions which terminate at their forward ends at inwardly turned forward portions, which in turn terminate at said downwardly projecting wheel supporting tines; said central portions terminating at their rear portions at downwardly and rearwardly angled short portions, which in turn terminate at rearwardly extending, generally parallel spaced handles.

16. The device of claim 5 in which the angle between said forward members and said tines is about 130°; the angle between said center portion and said short portions is approximately 150°; and the angle between said short members and said handles is approximately 150°.

17. The device of claim 1 in which a frame cross member joins said side members together at a point spaced sufficiently rearwardly along the length of said side members from said laterally projecting supports that it does not interfere with the opening in a removeably mounted container.

18. The device of claim 1, in which a stop member which projects downwardly from said frame, near said wheel;
said device being invertible such that said stop member is projecting upwardly from said frame instead of downwardly, whereby objects can be loaded onto said frame in abutting engagement with said stop member and conveyed.
